(19) United States
(12) Patent Application Publication
(10) Pub. No.: US 2017/0304950 A1
(43) Pub. Date: Oct. 26, 2017

(54) METHOD OF CREATING A SUBSURFACE 3D ENGRAVING IN A CRYSTAL

(71) Applicant: ULTRASOUND BABY FACE LTD, Bristol (GB)

(72) Inventor: Thomas MOORE, Bristol (GB)

(73) Assignee: ULTRASOUND BABY FACE LTD, Bristol (GB)

(21) Appl. No.: 15/505,920

(22) PCT Filed: Jul. 1, 2015
(86) PCT No.: PCT/GB2015/051927

§ 371 Date: Feb. 22, 2017

(30) Foreign Application Priority Data
Jul. 2, 2014 (GB) 1411815.2

(51) Int. Cl. B23K 26/50; B23K 26/00; B44F 1/04; B44C 5/00; G05B 19/418; B23K 103/00

(52) U.S. Cl. CPC B23K 26/50; B44C 5/00; B23K 26/0006; G05B 19/41885; B44F 1/04; B23K 26/0054; B23K 2203/50; G05B 2219/45163

(57) ABSTRACT

A method of creating a subsurface engraved crystal comprising the steps of: performing a 3D/4D scan of a subject; saving the volumetric data; generating a point cloud based on the volumetric data; outputting the point cloud to a laser engraver; and engraving a crystal with the laser engraver.

The present invention relates to a method and apparatus for creating a subsurface 3D engraving in a crystal.

### BACKGROUND

Crystals containing subsurface engravings are popular souvenir items which can be commonly found in tourist hotspots. There are also existing companies that produce subsurface engraved crystals based on photographs supplied by customers. These crystals are produced on the basis of a 2D photograph, with depth information being extrapolated from the photograph from known image processing algorithms. As a result, the engraving in the final crystal gives a quasi-3D effect, however the engraving is not truly 3D. No information regarding the rear view of subjects in a photograph can be derived from a 2D photograph by any image processing method, and so this information is lost in the process of converting a 2D image of the subject to 3D engraving.

### DESCRIPTION OF THE INVENTION

An aim of the present invention is to overcome some of the shortcomings associated with prior art crystal engraving apparatuses and methods. This aim is achieved by attaining volumetric data associated with a subject from a 3D/4D scan and creating a subsurface engraved crystal based on said data.

### SUMMARY OF THE INVENTION

According to a first embodiment of the invention there is provided a method of creating a subsurface engraved crystal comprising the steps of: performing a 3D/4D scan of a subject; saving the volumetric data; generating a point cloud based on the processed volumetric data; outputting the point cloud to a laser engraver; and engraving a crystal with the laser engraver.

According to a second embodiment of the invention there is provided an apparatus for creating a subsurface engraved crystal comprising: means for performing a 3D/4D scan of a subject; a storage means for saving the volumetric data; means for generating a point cloud based on the processed volumetric data; and means for outputting the point cloud to a laser engraver, which then engraves a crystal.

According to a third embodiment of the invention there is provided a method of generating a point cloud which corresponds to a three-dimensional representation of a subject, the method comprising the steps of: performing a 3D/4D scan of the subject to produce volumetric data; saving the volumetric data; and generating a point cloud based on the volumetric data.

### DETAILED DESCRIPTION

The invention will now be described with reference to the accompanying drawings, in which:

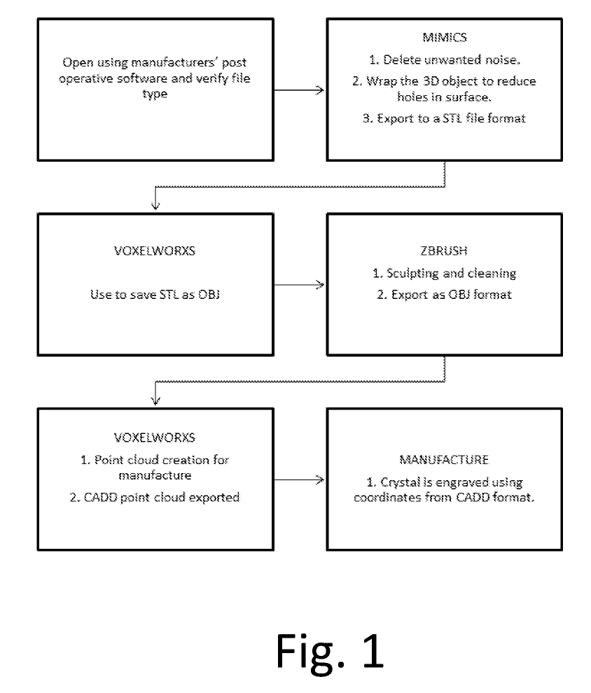

FIG. 1 schematically shows a flow chart outlining the steps of an embodiment of the present invention; and

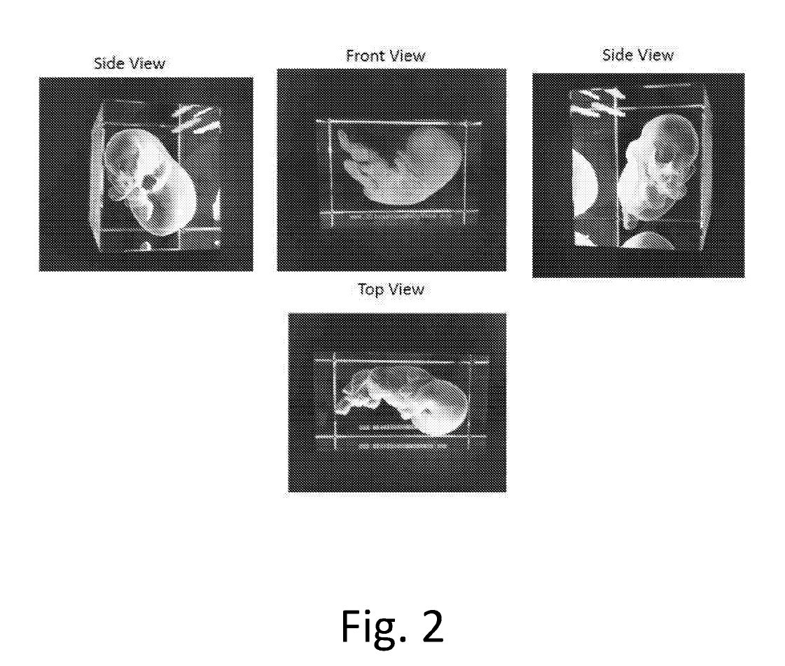

FIG. 2 shows an engraved crystal produced by an embodiment of the present invention.

An embodiment of a method according to the present invention will now be described, with each step discussed in detail.

### Performing a 3D/4D Scan of a Subject

In this embodiment, the 3D/4D scan comprises an ultrasound scan, and the subject comprises a foetus in utero. Pregnant women often undergo such scans during pregnancy, either voluntarily or because they are referred by a doctor, and the volumetric data from such scans is saved as a normal part of the procedure.

### Saving the Volumetric Data

File formats used in the method of the invention should store volume information about a subject. For the present embodiment, suitable file formats include, for example, Scan.v00 (Ultrasound Machine Export format) and Scan.vol (Ultrasound Machine Export format). The exporting of the volume file is typically done in cartesian (x, y, z) format, although other co-ordinate systems, such as spherical co-ordinates (r, κ, φ), may also be used. Ultrasound machines that export these formats include, for example, Voluson® 730 Pro & Expert, Voluson® I, Voluson® E6 and Voluson® E8, manufactured by GE Healthcare. The volumetric data may be stored on a local hard drive, a removable flash drive (e.g. a USB stick), transmitted to an off-site storage over a network, or saved in a cloud-based storage system.

Importing Volumetric Data into an Image Processor

Any suitable image processor may be used in the invention. A programme for use in the present embodiment may be, for example, Mimics Software. Mimics Software is used as a medical programme to help surgeons design surgical implants. Saved .v00 and .vol files may be imported into Mimics Software.

### Processing the Volumetric Data to Isolate the Region of Interest and Remove Unwanted Artefacts (Optional)

If the scan is sufficiently focussed and free of artefacts, the volumetric data may simply be output as a point cloud (see below). However, it is often necessary to perform an image processing step on the volumetric data first.

This step may either be automated (through the use of image processing algorithms), or performed by an operator by hand. In the present embodiment, an operator having imported volume data into Mimics Software may to isolate the region of interest (ROI), which will comprise the foetus, and then crop the image to fit the ROI. The anterior and posterior of the foetus will need to be identified to correctly orient the foetus. This can be done by identifying a feature on the front of the foetus, for example the nose, and designating the side having that feature as the anterior. The opposite side can then be designated as the posterior.

Next, artefacts appearing in the data which do not comprise the foetus (e.g. lumps projecting from the foetus, or floating debris) can be selected and deleted to leave a clean 3D image of the foetus. As well as artefact removal, the model of the foetus may undergo a clean-up process to improve the image quality. This may comprise applying a smoothing tool, or triangle reduction tool, to the foetus model.

### Generating a Point Cloud Based on the Processed Volumetric Data

The volumetric data is then output as a point cloud. This involves exporting the volumetric data as any suitable point cloud format. In the present embodiment, the data is exported from Mimics Software as a .stl file, however other file types may also be used.

Preferably, the .stl file is converted to a .obj file using a programme such as Voxelworxs. It is preferable to use .obj files, as .stl files contain only geometry information, whereas .obj files carry both geometry information and colour/texture maps and materials. This gives the surface of the foetus different light reflective abilities, which results in a more accurate engraving.

The .obj file is then opened in a computer programme capable of converting .obj files to point clouds. In the present embodiment, Zbrush is used.

Before generating the point cloud, the processed volumetric data may undergo further processing, such as rescaling to fit standard crystal dimensions. Shading and light effects can also be applied before the point cloud is generated. In the present embodiment, the point cloud is saved in a .cadd file format.

### Outputting the Point Cloud to a Laser Engraver

The point cloud is a data format which is readable by many prior art laser engravers. The laser engraver performs subsurface etching on a crystal, etching one point for every point in the point could to build up a 3D image within the crystal which is viewable from all angles. In the present embodiment, a crystal with a refractive index of 1.52 is used, however crystals of higher or lower refractive index may also be used.

A readily identifiable difference between crystals made by the method of the present invention and crystals made by prior art methods is that the engravings made by the present method are truly three-dimensional. As the point cloud from which the laser crystal makes the engraving is derived from volumetric data, and not inferred from a two-dimensional photograph, information about the posterior of the subject is not lost. The subject can therefore be viewed from all angles.

The above examples are merely illustrative embodiments of the invention, and various alternatives and modifications will be apparent to those skilled in the art. For example, the 3D/4D scan need not be an ultrasound scan. Other scans, such as, for example, magnetic resonance imaging (MRI) or x-ray computed tomography (CT) scans, may also be used. The subject of the scan need not be a foetus, but any subject for which volumetric data can be produced via a 3D/4D scan. Alternative subjects include, for example, bodily organs, bones, etc. The crystals produced by the method of the present invention can be used as souvenirs or mementos, but may also be used in medical teaching or as a medical record. The laser engraver could be a separate, stand-alone laser engraver, or it could be formed integrally with the rest of the apparatus, e.g. formed integrally with the means for performing the 3D/4D scan, with the storage means, with the means for generating a point cloud or the means for generating the point cloud. In some embodiments the apparatus may be a unitary apparatus, wherein all of the constituent components are integral with one another.

1. A method of creating a subsurface engraved crystal comprising the steps of:
performing a 3D/4D scan of a subject to produce volumetric data;
saving the volumetric data;
generating a point cloud based on the volumetric data;
outputting the point cloud to a laser engraver; and
engraving a crystal with the laser engraver.

2. A method according to claim 1, further comprising the steps of:
importing said data into an image processor; and
processing the volumetric data to isolate the region of interest and remove unwanted artefacts, prior to generating the point cloud.

3. A method according to claim 1, further comprising the step of rescaling the volumetric data to fit standard crystal dimensions, prior to generating the point cloud.

4. A method according to claim 1, wherein the step of saving the volumetric data comprises saving the volumetric data to a removable flash memory.

5. (canceled)

6. A method according to claim 1, wherein the step of saving the volumetric data comprises saving the volumetric data to a local hard drive.

7. A method according to claim 1, wherein the step of saving the volumetric data comprises transmitting the volumetric data to an off-site storage system over a network.

8. A method according to claim 1, wherein the step of saving the volumetric data comprises saving the volumetric data in a cloud-based storage system.

9. A method according to any preceding claim, wherein the 3D/4D scan comprises an ultrasound scan, wherein the subject comprises a fetus in utero.

10. (canceled)

11. An apparatus for creating a subsurface engraved crystal comprising:
means for performing a 3D/4D scan of a subject;
a storage means for saving the volumetric data;
means for generating a point cloud based on the volumetric data; and
means for outputting the point cloud to a laser engraver, which then engraves a crystal.

12. An apparatus according to claim 11, further comprising an image processor, said volumetric data being imported to the image processor which processes the volumetric data to isolate the region of interest and remove unwanted artefacts.

13. An apparatus according to claim 11, wherein the volumetric data is rescaled in the image processor to fit standard crystal dimensions.

14. An apparatus according to claim 11, wherein the storage means comprises a removable flash memory.

15. (canceled)

16. An apparatus according to claim 11, wherein the storage means comprises a local hard drive.

17. An apparatus according to claim 11, wherein the storage means comprises an off-site storage system accessible over a network.

18. An apparatus according to claim 11, wherein the storage means comprises a cloud-based storage system.

19. An apparatus according to claim 11, wherein the means for performing a 3D/4D scan comprises an ultrasound scanner, wherein the subject comprises a fetus in utero.

20. (canceled)

21. An apparatus according to claim 11, wherein the laser engraver is integral with the apparatus.

22. A crystal produced by the method of claim 1.

23. (canceled)

24. (canceled)

25. (canceled)

26. (canceled)
